(19) United States
(12) Patent Application Publication
(10) Pub. No.: US 2026/0220815 A1
(43) Pub. Date: Jul. 30, 2026

(54) IMAGE PROCESSING DEVICE, IMAGE PROCESSING METHOD, AND IMAGE PROCESSING PROGRAM

(71) Applicant: NTT, Inc., Tokyo (JP)

(72) Inventors: Shuhei YOSHIDA, Musashino-shi, Tokyo (JP); Hiroyuki UZAWA, Musashino-shi, Tokyo (JP); Saki HATTA, Musashino-shi, Tokyo (JP); Yuko IINUMA, Musashino-shi, Tokyo (JP); Yuya OMORI, Musashino-shi, Tokyo (JP); Yusuke HORISHITA, Musashino-shi, Tokyo (JP); Daisuke KOBAYASHI, Musashino-shi, Tokyo (JP); Ken NAKAMURA, Musashino-shi, Tokyo (JP)

(73) Assignee: NTT, Inc., Tokyo (JP)

(21) Appl. No.: 19/144,638

(22) PCT Filed: Jan. 13, 2023
(86) PCT No.: PCT/JP2023/000871

§ 371 Date: Jun. 30, 2025

(51) Int. Cl. G06T 7/73; G06T 3/40; G06V 10/25; G06V 10/26; G06V 10/75; G06V 40/10

(52) U.S. Cl. CPC G06T 7/74; G06T 3/40; G06V 10/25; G06V 10/26; G06V 10/751; G06V 10/759; G06V 40/10; G06T 2207/20021; G06T 2207/30196

(57) ABSTRACT

An image processing apparatus includes: a division unit that divides an input image including at least one person and outputs plural first images; a first processing unit that obtains first skeleton information that is skeleton information for a person included in each of the plural first images by giving, as an input, each of the plural first images to a learned model that has learned in advance to receive an image as an input and to output the skeleton information including positions of plural feature points and a connection relationship between the feature points for each person included in the input image. Further, there is a scaling unit that outputs a second image, a second processing unit that obtains second skeleton information, and a selection unit that selects one of the first skeleton information or the second skeleton information.

### TECHNICAL FIELD

The disclosed technique relates to an image processing apparatus, an image processing method, and an image processing program.

### BACKGROUND ART

In recent years, a technique for estimating the posture of a person included in an image using deep learning such as a convolutional neural network (CNN) has been proposed. In the posture estimation technique, the posture of the person is estimated by estimating skeleton information including the positions of a plurality of feature points such as joints, eyes, and a nose of the person included in the image and a connection relationship between the feature points (corresponding to a bone of a human body). Such a posture estimation technique is hoped to be applied to edge artificial intelligence (AI) applications, which detect a suspicious person from a video of a security camera or the like.

In edge devices with limited memory resources, there may be restrictions on the size of an image used for posture estimation. Therefore, for example, in a case where posture estimation is performed using a high definition image such as full high definition (HD) And 4K, a method that reduces the size of the image can be conceived. However, since reducing the size of the image means that the person included in the image is also downsized, it is difficult to estimate the posture of the person appearing particularly small.

In addition, for example, a method that divides the original image and performs posture estimation for each of the divided images is also conceivable. In this case, since the body of the person on the boundary of the divided images is divided, it is difficult to identify the positions of the feature points and the connection relationship between the feature points, and the accuracy of the posture estimation decreases.

As described above, as a technique for performing image recognition in a case where there are restrictions on the processable image size, for example, Patent Literature 1 discloses a method that detects an object from each of images obtained by dividing an input image and an image obtained by reducing the size of the input image, and combining the results.

### CITATION LIST

### Patent Literature

Patent Literature 1: WO 2021/161513 A

### SUMMARY OF INVENTION

### Technical Problem

In the technique described in Patent Literature 1, a position of an object included in the image is identified using information of a square frame surrounding the object detected from each of the divided image and the reduced image. However, in the case of posture estimation of the posture of the person included in the image, it is required to identify more precise information such as skeleton information including the positions of a plurality of feature points such as joints, eyes, and a nose and a connection relationship between the feature points.

The disclosed technique has been made in view of the above points, and an object thereof is to provide an image processing apparatus, an image processing method, and an image processing program that enable more accurate posture estimation.

### Solution to Problem

A first aspect of the present disclosure is an image processing apparatus including: a division unit that divides an input image including at least one person and outputs plural first images; a first processing unit that obtains first skeleton information that is skeleton information for a person included in each of the plural first images by giving, as an input, each of the plural first images to a learned model that has learned in advance to receive an image as an input and to output the skeleton information including positions of plural feature points and a connection relationship between the feature points for each person included in the input image; a scaling unit that outputs a second image obtained by reducing the size of the input image; a second processing unit that obtains second skeleton information that is the skeleton information for a person included in the second image by giving, as an input, the second image to the learned model; and a selection unit that selects one of the first skeleton information or the second skeleton information based on the first skeleton information and the second skeleton information and outputs the selected information as the skeleton information for each person included in the input image.

A second aspect of the present disclosure is an image processing method including: dividing, by a division unit, an input image including at least one person and outputting plural first images; obtaining, by a first processing unit, first skeleton information that is skeleton information for a person included in each of the plural first images by giving, as an input, each of the plural first images to a learned model that has learned in advance to receive an image as an input an image and to output the skeleton information including positions of plural feature points and a connection relationship between the feature points for each person included in the input image; outputting, by a scaling unit, a second image obtained by reducing the size of the input image; obtaining, by a second processing unit, second skeleton information that is the skeleton information for a person included in the second image by giving, as an input, the second image to the learned model; and selecting, by a selection unit, one of the first skeleton information or the second skeleton information based on the first skeleton information and the second skeleton information and outputting the selected information as the skeleton information for each person included in the input image.

A third aspect of the present disclosure is an image processing program, and is a program for causing a computer to function as the image processing apparatus of the first aspect.

### Advantageous Effects of Invention

According to the disclosed technology, it is possible to perform posture estimation with higher accuracy.

### BRIEF DESCRIPTION OF DRAWINGS

FIG. 1 is a diagram for describing an outline of a technique of the present disclosure.

FIG. 2 is a block diagram illustrating an example of a hardware configuration of an image processing apparatus.

FIG. 3 is a block diagram illustrating a configuration of the image processing apparatus.

FIG. 4 is a diagram for describing processing of a determination unit.

FIG. 5 is a diagram for describing processing of a selection unit.

FIG. 6 is a flowchart illustrating a flow of image processing.

FIG. 7 is a flowchart illustrating a flow of division processing.

FIG. 8 is a flowchart illustrating a flow of size reduction processing.

FIG. 9 is a flowchart illustrating a flow of selection processing according to a first embodiment.

FIG. 10 is a diagram for describing processing of a selection unit according to a second embodiment.

### DESCRIPTION OF EMBODIMENTS

Hereinafter, an example of an embodiment of the disclosed technique will be described with reference to the drawings. Note that the same or equivalent components and parts will be given the same reference numerals in the drawings. In addition, dimensional ratios in the drawings are exaggerated for convenience of description, and may be different from actual ratios.

[Overview of Present Disclosure]

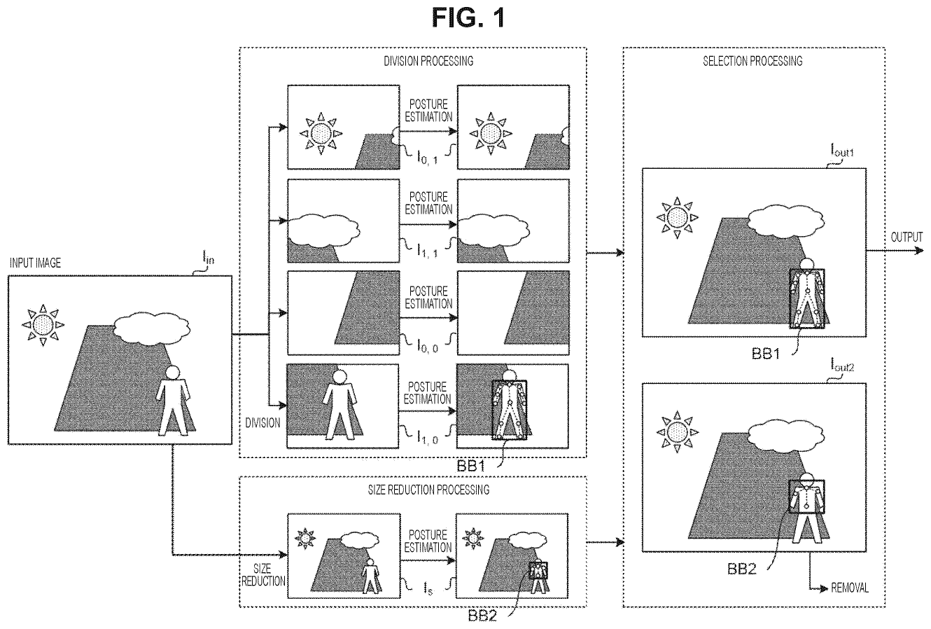

First, an overview of the present disclosure will be described with reference to FIG. 1. The technique of the present disclosure relates to a technique that estimates a posture of a person included in an image by estimating skeleton information including the positions of a plurality of feature points such as joints, eyes, and a nose of the person included in the image and a connection relationship between the feature points (corresponding to a bone of a human body). In FIG. 1, feature points of the person are illustrated by white circles, and a connection relationship between the feature points is illustrated by dotted lines. Such a posture estimation technique is hoped to be applied to edge AI applications, which, for example, detect a suspicious person from a video of a security camera or the like.

As illustrated in FIG. 1, in the technique of the present disclosure, both division processing and size reduction processing are executed: the former is to perform posture estimation based on a divided image I_{i,j} obtained by dividing an input image Iᵢₙ into a plurality of images and the latter is to perform posture estimation based on a reduced image Iₛ obtained by reducing the size of the input image Iᵢₙ. In addition, highly accurate posture estimation (output of skeleton information) is realized by comparing the result of the division processing with the result of the size reduction processing, and selecting the one estimated to be more accurate. Hereinafter, an image processing apparatus 1 of the present disclosure will be described in detail.

### First Embodiment

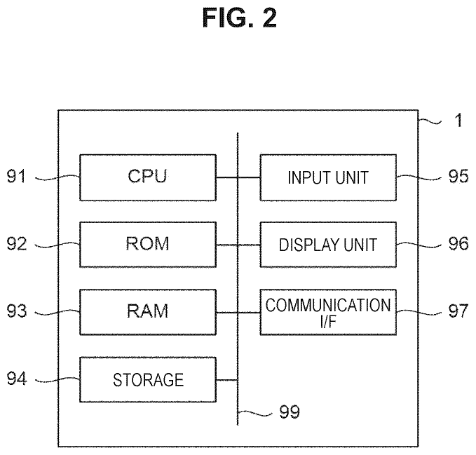

First, a hardware configuration of the image processing apparatus 1 according to a first embodiment will be described with reference to FIG. 2. FIG. 2 is a block diagram illustrating a hardware configuration of the image processing apparatus 1. As illustrated in FIG. 2, the image processing apparatus 1 includes a central processing unit (CPU) 91, a read only memory (ROM) 92, a random access memory (RAM) 93, a storage 94, an input unit 95, a display unit 96, and a communication interface (I/F) 97. The components are communicatively connected with each other via a bus 99.

The CPU 91 is a central processing unit that executes various programs and controls each unit. That is, the CPU 91 reads a program from the ROM 92 or the storage 94 and executes the program using the RAM 93 as a working area. The CPU 91 controls each of the components described above and performs various types of arithmetic processing in accordance with the program stored in the ROM 92 or the storage 94. In the present embodiment, the ROM 92 or the storage 94 stores an image processing program for executing image processing to be described below. The image processing program may be one program or a group of programs including a plurality of programs or modules.

The ROM 92 stores various programs and various types of data. The RAM 93 serving as the working area temporarily stores a program or data. The storage 94 includes a storage device such as a hard disk drive (HDD) or a solid state drive (SSD), and stores various programs including an operating system and various types of data.

The input unit 95 includes a pointing device such as a mouse and a keyboard, and is used to perform various inputs. The display unit 96 is, for example, a liquid crystal display, and displays various types of information. The display unit 96 may function as the input unit 95 by employing a touch panel system.

The communication I/F 97 is, for example, an interface for communicating with other devices such as a camera that captures an input image and a database server that stores the input image captured by the camera. For the communication, for example, wired communication standards such as Ethernet (registered trademark) or fiber distributed data interface (FDDI), or wireless communication standards such as 4G, 5G, or Wi-Fi (registered trademark) are used.

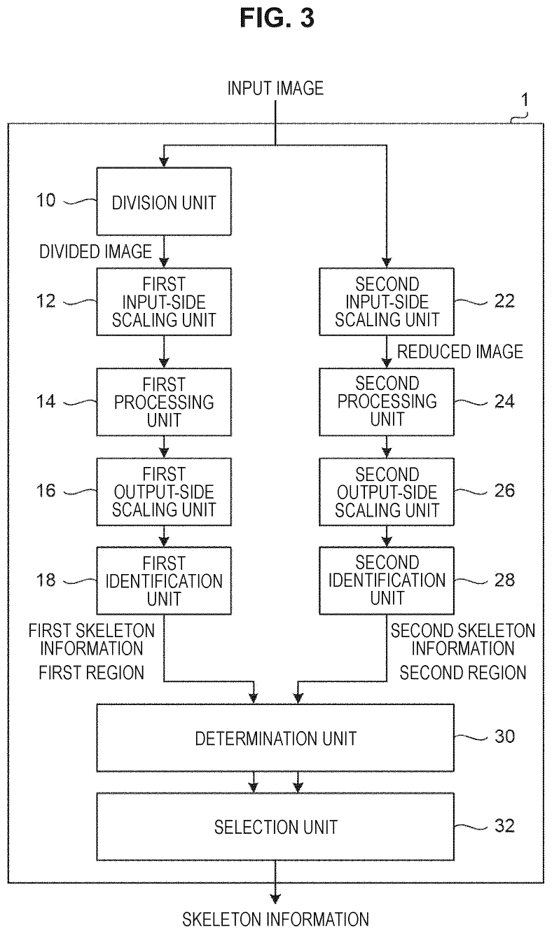

Next, a functional configuration of the image processing apparatus 1 will be described with reference to FIGS. 3 to 5. FIG. 3 is a block diagram illustrating an example of the functional configuration of the image processing apparatus 1. As illustrated in FIG. 3, the image processing apparatus 1 includes, as functional components, a division unit 10, a first input-side scaling unit 12, a first processing unit 14, a first output-side scaling unit 16, and a first identification unit 18. In addition, the image processing apparatus 1 includes, as the functional components, a second input-side scaling unit 22, a second processing unit 24, a second output-side scaling unit 26, and a second identification unit 28. Furthermore, the image processing apparatus 1 includes a determination unit 30 and a selection unit 32 as the functional components. Each functional component is implemented by the CPU 91 reading the image processing program stored in the ROM 92 or the storage 94, developing the image processing program in the RAM 93, and executing the image processing program.

<Division Processing>

First, the division processing (see FIG. 1) for performing posture estimation based on the divided image I_{i,j} obtained by dividing the input image Iᵢₙ into a plurality of images will be described. The division unit 10, the first input-side scaling unit 12, the first processing unit 14, the first output-side scaling unit 16, and the first identification unit 18 are functional blocks that execute the division processing.

The division unit 10 divides the input image Iᵢₙ including at least one person and outputs a plurality of divided images. Specifically, the division unit 10 divides the input image Iᵢₙ into a plurality of divided images I_{i,j} (0≤i≤N_{(w-1)}, 0≤j≤N₍ₕ₋₁₎), where the number of divisions in the width direction of the input image Iᵢₙ is N_{w} and the number of divisions in the height direction is Nₕ. The number of divisions N_{w} in the width direction and the number of divisions Nₕ in the height direction may be determined in advance or may be specified by the user via the input unit 95 or the like. In addition, for example, the division unit 10 may determine the number of divisions N_{w} in the width direction and the number of divisions Nₕ in the height direction according to the size of the input image Iᵢₙ and a restricted size of a posture estimation model to be described later.

In the “division processing” in FIG. 1 and the following embodiments, an example in which the input image Iᵢₙ is divided into a total of four divided images I_{0,0} to I_{1,1} with N_{w}=2 and Nₕ=2, but the number of divisions is not limited thereto. The input image Iᵢₙ may be a high-definition input image such as full HD or 4K. The divided image I_{i,j} is an example of a first image of the present disclosure.

The first input-side scaling unit 12 scales (reduces and/or enlarges) each of the plurality of divided images I_{i,j} output from the division unit 10 so as to conform to a restricted size predefined as a size of an image that can be input to the posture estimation model to be described later. As a scaling method, for example, a known method such as a bilinear interpolation method can be appropriately applied.

Note that the input-side scaling of the divided image I_{i,j} by the first input-side scaling unit 12 is not essential, and the input-side scaling can be omitted, for example, in a case where the size of the divided image I_{i,j} divided by the division unit 10 is already equal to or smaller than the restricted size. In addition, for example, the first input-side scaling unit 12 may scale (reduce) the input image Iᵢₙ so as to make the size of the divided image I_{i,j} equal to or smaller than the constraint size before the division unit 10 divides the input image Iᵢₙ.

The first processing unit 14 obtains first skeleton information that is skeleton information of a person included in each of the plurality of divided images I_{i,j} by giving, as an input, each of the plurality of divided images I_{i,j} output from the division unit 10 to the posture estimation model. The skeleton information is information including the positions of the plurality of feature points such as joints, eyes, and nose, that is, coordinates in each of the divided images I_{i,j}, and the connection relationship between the feature points (corresponding to a bone of a human body). In the example of FIG. 1, the first skeleton information is not acquired from the divided images I_{0,0}, I_{0,1}, and I_{1,1} in which no person is included, and the first skeleton information is acquired for the person included in the divided images I_{1,0}.

The posture estimation model includes, for example, a machine learning model such as CNN, and is a learned model learned in advance so as to receive an image as an input and output the skeleton information including the positions of the plurality of feature points and the connection relationship between the feature points for each person included in the input image. The posture estimation model may be stored in, for example, a storage medium such as the storage 94 or may be stored in an external cloud server. As a technique for estimating the posture of the person (outputting the skeleton information) based on such an image, a known method can be appropriately applied.

The first output-side scaling unit 16 maps the first skeleton information acquired by the first processing unit 14 on the original image before the division (input image Iᵢₙ). As described above, the first skeleton information includes the coordinates in the divided image I_{i,j} as the position of the feature point because it is required to derive the position of the feature point in the original image before the division (input image Iᵢₙ) to compare with the second skeleton information to be described later.

For example, the size of the input image Iᵢₙ is defined as Wᵢₙ (width)×Hᵢₙ (height), the size of one divided image I_{i,j} is defined as W_{det} (width)×H_{det} (height), and the size of a combined image I_{c} formed by combining all the divided images is defined as W_{c} (width)×H_{c} (height). W_{c} and H_{c} are expressed as follows using the number of divisions N_{w} in the width direction and the number of divisions Nₕ in the height direction of the input image Iᵢₙ described above. Note that the widths Wᵢₙ, W_{det}, and W_{c} refer to lengths along the horizontal direction of the paper surface as illustrated in FIG. 1, and the heights Hᵢₙ, H_{det}, and H_{c} refer to lengths in the vertical direction of the paper surface.

$${W}_{C} = {N}_{w} \times {W}_{det}$$

$${H}_{C} = {N}_{h} \times {H}_{det}$$

In a case where W_{c} does not coincide with Wᵢₙ and H_{c} does not coincide with Hᵢₙ, the size does not become the same as that of the input image Iᵢₙ only when all the divided images are simply combined because the input-side scaling to the divided image I_{i,j} has been performed by the first input-side scaling unit 12. Then, the first output-side scaling unit 16 scales the size of the combined image I_{c} such that W_{c} coincides with Wᵢₙ and H_{c} coincides with Hᵢₙ. Alternatively, the first output-side scaling unit 16 may scale the size of the input image Iᵢₙ (original image) such that W_{c} coincides with Wᵢₙ and H_{c} coincides with Hᵢₙ.

Thereafter, the first output-side scaling unit 16 maps the coordinates of each feature point in the divided image I_{i,j} included in the first skeleton information acquired by the first processing unit 14 on the input image Iᵢₙ (original image). For example, when coordinates of a feature point in a certain divided image I_{i,j} are defined as (xbb_{div}, ybb_{div}) and coordinates in a case where the feature point is mapped on the input image Iᵢₙ (original image) are defined as (xbb, ybb), the coordinates (xbb, ybb) are expressed as follows.

$$xbb = {xbb}_{div} + {W}_{det} \times i$$

$$ybb = {ybb}_{div} + {H}_{det} \times j$$

The first identification unit 18 identifies a first region surrounding the person included in each of the plurality of divided images I_{i,j} based on the first skeleton information acquired by the first processing unit 14. In FIG. 1, a frame BB1 indicating the first region identified by the first identification unit 18 is illustrated by a thick line on the divided image I_{1,0} and the output image Iₒᵤₜ₁ (the combined image I_{c} after the scaling). The frame BB1 indicating the first region is also called a bounding box, and has, for example, a minimum rectangular range that can surround the detected person by circumscribing the person (the plurality of feature points).

### <Size Reduction Processing>

First, the size reduction processing (see FIG. 1) for performing posture estimation based on the reduced image Iₛ obtained by reducing the size of the input image Iᵢₙ will be described. While the above-described division processing is to perform posture estimation based on each of the plurality of divided images I_{i,j} obtained by dividing the input image Iᵢₙ, the size reduction processing is to perform posture estimation based on the reduced image Iₛ including the entire input image Iᵢₙ. The second input-side scaling unit 22, the second processing unit 24, the second output-side scaling unit 26, and the second identification unit 28 are functional blocks that execute the size reduction processing.

The second input-side scaling unit 22 outputs the reduced image Iₛ obtained by reducing the size of the input image Iᵢₙ. Specifically, the second input-side scaling unit 22 scales (reduces) the input image Iᵢₙ to conform to the restricted size of the posture estimation model. As a scaling method, for example, a known method such as a bilinear interpolation method can be appropriately applied. The second input-side scaling unit 22 is an example of a scaling unit of the present disclosure. The reduced image Iₛ is an example of a second image of the present disclosure.

The second processing unit 24 obtains second skeleton information that is skeleton information of a person included in the reduced image Iₛ by giving, as an input, the reduced image Iₛ output from the second input-side scaling unit 22 to the posture estimation model. The second skeleton information is information including the positions of the plurality of feature points such as joints, eyes, and a nose, that is, coordinates in the reduced image, and the connection relationship between the feature points.

The second output-side scaling unit 26 maps the second skeleton information acquired by the second processing unit 24 on the original image before the size reduction (input image Iᵢₙ). As described above, the second skeleton information includes the coordinates in the reduced image Iₛ as the position of the feature point because it is required to derive the position of the feature point in the original image before the size reduction (input image Iᵢₙ) to compare with the first skeleton information.

For example, the size of the input image Iᵢₙ is defined as Wᵢₙ (width)×Hᵢₙ (height), and the size of the reduced image Iₛ is defined as W_{det} (width)×H_{det} (height). The second output-side scaling unit 26 maps the coordinates of each feature point in the reduced image Iₛ included in the second skeleton information acquired by the second processing unit 24 on the input image Iᵢₙ (original image). For example, when coordinates of a feature point in the reduced image Iₛ are defined as (xₛ, yₛ) and coordinates in a case where the feature point is mapped on the input image Iᵢₙ (original image) are defined as (xᵢₙ, yᵢₙ), the coordinates (xᵢₙ, yᵢₙ) are expressed as follows.

$${x}_{in} = {x}_{s} \times {W}_{in} / {W}_{det}$$

$${y}_{in} = {y}_{s} \times {H}_{in} / {H}_{det}$$

The second identification unit 28 identifies a second region surrounding the person included in the reduced image Iₛ based on the second skeleton information acquired by the second processing unit 24. In FIG. 1, a frame BB2 indicating the second region identified by the second identification unit 28 is illustrated by a thick line on the reduced image Iₛ and the output image Iₒᵤₜ₂ (the reduced image Iₛ after the scaling). The frame BB2 indicating the second region is also called a bounding box, and has, for example, a minimum rectangular range that can surround the detected person by circumscribing the person (the plurality of feature points).

As described above, as a result of the division processing (that is, posture estimation based on the divided image I_{i,j}), the first skeleton information and the first region of the person included in the input image Iᵢₙ are obtained. In addition, as a result of the size reduction processing (that is, posture estimation based on the reduced image Iₛ), the second skeleton information and the second region are obtained.

### <Selection Processing>

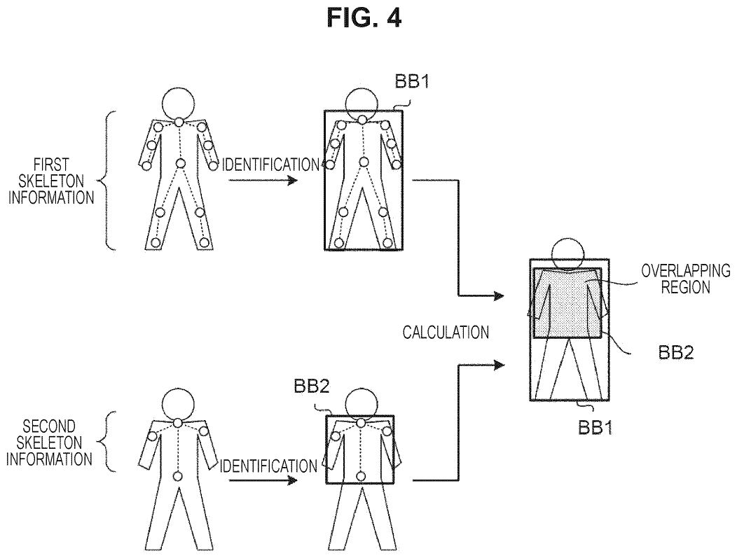

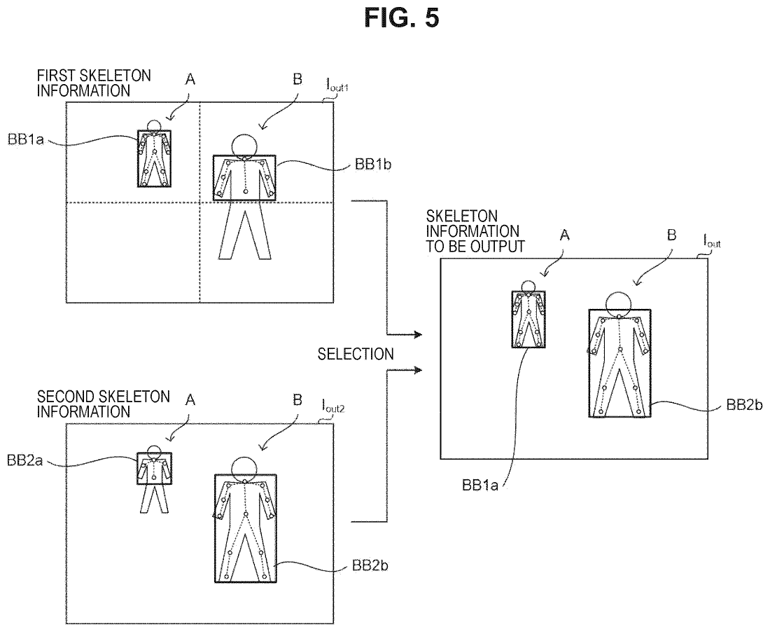

Next, selection processing for selecting either the result of the division processing or the result of the size reduction processing will be described. FIGS. 4 and 5 illustrate a diagram for describing the selection processing. In a case where the entire body is large enough to fit in each of the divided images I_{i,j}, as illustrated in a person A in FIG. 5, the accuracy of the skeleton information tends to be higher in the result of the division processing than in the result of the size reduction processing. On the other hand, in a case where the entire body straddles the boundary of the divided images I_{i,j}, as illustrated in a person B, the accuracy of the skeleton information tends to be higher in the result of the size reduction processing than in the result of the division processing.

The image processing apparatus 1 according to the present embodiment selects, between the result of the division processing and the result of the size reduction processing, the one estimated to be accurate as a final output result. The determination unit 30 and the selection unit 32 are functional blocks that execute the selection processing.

The determination unit 30 determines whether the first skeleton information and the second skeleton information corresponding to each other are related to the same person by comparing the first region with the second region. That is, the determination unit 30 first associates the first skeleton information and the second skeleton information related to the same person so as to prevent the skeleton information of a different person from being mixed up and output. In the present embodiment, the determination unit 30 determines whether the first skeleton information and the second skeleton information are related to the same person for each combination of the first skeleton information and the second skeleton information.

FIG. 4 illustrates the first skeleton information acquired based on the divided image I_{i,j}, the first region identified based on the first skeleton information, the second skeleton information acquired based on the reduced image Iₛ, and the second region identified based on the second skeleton information. As illustrated in FIG. 4, the determination unit 30 calculates an area of an overlapping region (hereinafter referred to as “overlapping area”) in which the first region illustrated in the frame BB1 and the second region illustrated in the frame BB2 overlap each other.

In addition, the determination unit 30 calculates a first value obtained by dividing the calculated overlapping area by the area of the first region, and compares the first value with a predetermined first threshold. Since the overlapping area takes a value equal to or smaller than the area of the first region, the first value is equal to or greater than 0 and equal to or smaller than 1, and the greater the first value, the higher the certainty that the first region and the second region are related to the same person.

In addition, the determination unit 30 calculates a second value obtained by dividing the area of the first region by the area of the second region, and compares the second value with a predetermined second threshold. The greater the second value, the higher the certainty that the first region and the second region are related to the same person.

Then, the determination unit 30 determines whether the first skeleton information and the second skeleton information corresponding to each other are related to the same person according to a comparison result between the first value and the first threshold and a comparison result between the second value and the second threshold. Specifically, the determination unit 30 first refers to the comparison result between the first value and the first threshold, determines that there is a possibility that the first region and the second region are related to the same person in a case where the first value is equal to or greater than the first threshold, and refers to the comparison result between the second value and the second threshold. The determination unit 30 determines that the first skeleton information and the second skeleton information corresponding to each other are related to the same person in a case where the second value is equal to or greater than the second threshold.

On the other hand, in a case where the first value is less than the first threshold and in a case where the second value is less than the second threshold, the determination unit 30 determines that the first region and the second region are related to different persons. In this case, the first skeleton information and the second skeleton information corresponding to the first region and the second region are used again for the determination of another combination.

For the first skeleton information and the second skeleton information that have been determined to be related to the same person by the determination unit 30, the selection unit 32 selects one of the first skeleton information and the second skeleton information based on the first skeleton information and the second skeleton information. For example, the selection unit 32 may select, between the first skeleton information and the second skeleton information, the one with a larger number of connection relationships (number of bones) between the feature points included therein.

In the example of FIG. 5, for the person A, the number of connection relationships (bones) between the feature points included in the first region indicated by the frame BB1a is larger than the number of connection relationships (bones) between the feature points included in the second region indicated by the frame BB2a. Therefore, the selection unit 32 selects the first skeleton information for the person A.

On the other hand, in the example of FIG. 5, for the person B, the number of connection relationships (bones) between the feature points included in the second region indicated by the frame BB2b is larger than the number of connection relationships (bones) between the feature points included in the second region indicated by the frame BB1b. Therefore, the selection unit 32 selects the second skeleton information for the person B.

Note that, in a case where the first skeleton information and the second skeleton information have an equal number of connection relationships (the number of bones) between the feature points included therein, the selection unit 32 preferably selects the first skeleton information acquired based on the divided image I_{i,j}. This is because the positions and the like of the feature points are more accurate in the first skeleton information acquired based on the divided images I_{i,j} in many cases.

The selection unit 32 selects either the first skeleton information or the second skeleton information for each person included in the input image Iᵢₙ, and outputs the selected information as the final skeleton information. If a plurality of persons A and B are included in one output image Iₒᵤₜ as illustrated in FIG. 5, either the first skeleton information or the second skeleton information may be selected for each person and the selected information may be output as the skeleton information.

Note that the output form of the skeleton information is not particularly limited, and for example, as illustrated in FIG. 5, control may be performed such that the positions of the feature points, the connection relationship between the feature points, and the frame BB1 are illustrated in the input image Iᵢₙ to be displayed on the display unit 96. In addition, for example, the coordinates of the feature point and the coordinates of the first region may be output as text data.

In addition, for the first skeleton information and the second skeleton information that have been determined to be related to the same person, one of the skeleton information that has not been selected by the selection unit 32 may be deleted.

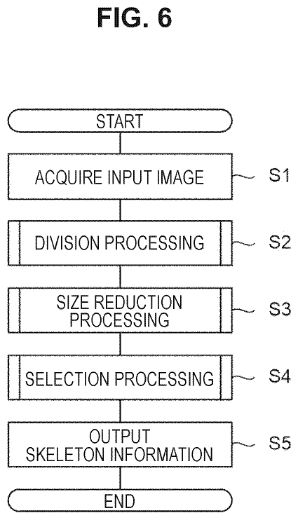

Next, an operation of the image processing apparatus 1 according to the present embodiment will be described. FIG. 6 is a flowchart illustrating a flow of image processing by the image processing apparatus 1. The image processing illustrated in FIG. 6 is performed by the CPU 91 reading the image processing program from the ROM 92 or the storage 94, developing the image processing program in the RAM 93, and executing the image processing program.

In step S1, the CPU 91 acquires the input image including at least one person. For example, the image is input to the image processing apparatus 1 as the input image by receiving an image captured by an external camera or the like via the communication I/F 97. In addition, a high-definition image may be used as the input image.

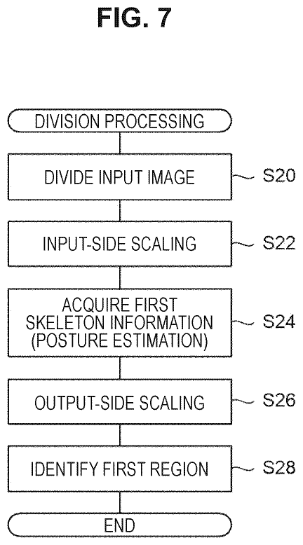

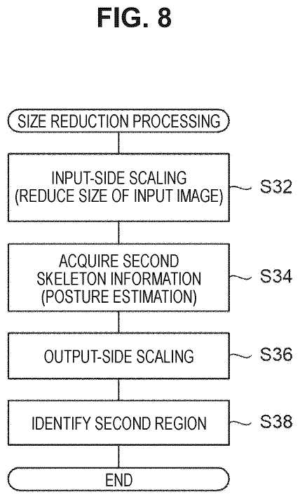

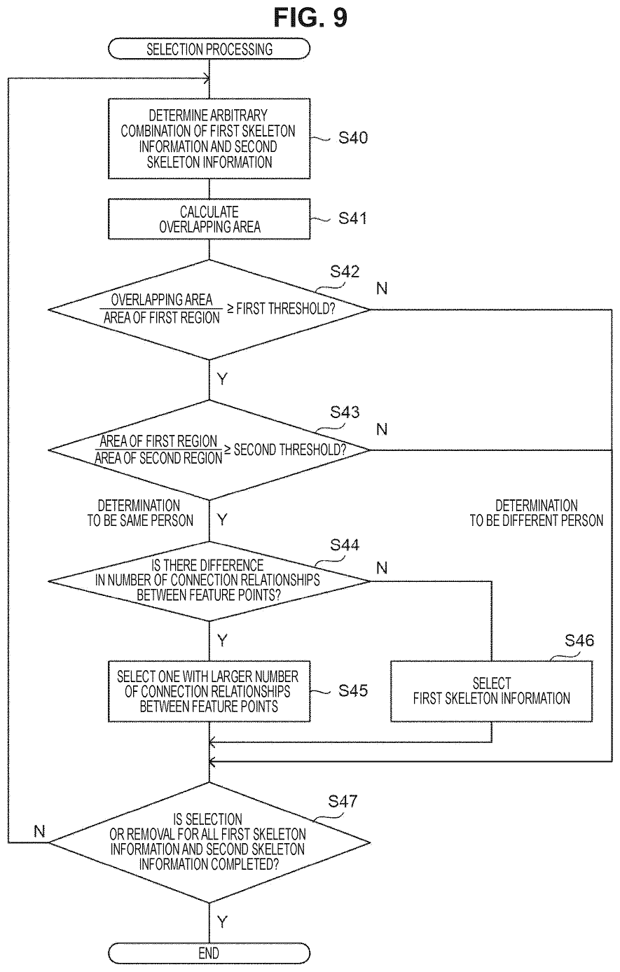

In step S2, the CPU 91 executes the division processing as the division unit 10, the first input-side scaling unit 12, the first processing unit 14, the first output-side scaling unit 16, and the first identification unit 18 (see FIG. 7). In step S3, the CPU 91 executes the size reduction processing as the second input-side scaling unit 22, the second processing unit 24, the second output-side scaling unit 26, and the second identification unit 28 (see FIG. 8). In step S4, the CPU 91 executes selection processing as the determination unit 30 and the selection unit 32 (see FIG. 9). In step S5, the CPU 91 outputs the skeleton information obtained by the selection processing in step S4, and ends the image processing. Note that the division processing in step S2 and the size reduction processing in step S3 may be executed in a different order, or may be executed in parallel.

Next, the division processing in step S2 will be described in detail with reference to FIG. 7. FIG. 7 is a flowchart illustrating a flow of the division processing. In step 20, the CPU 91, as the division unit 10, divides the input image acquired in step S1 and outputs the plurality of divided images. In step S22, the CPU 91, as the first input-side scaling unit 12, scales (reduces and/or enlarges) each of the plurality of divided images output in step S20 so as to conform to the restricted size of the posture estimation model. Note that, in a case where the plurality of divided images output in step S20 already conform to the restricted size of the posture estimation model, the processing in step S22 can be omitted.

In step S24, the CPU 91, as the first processing unit 14, obtains the first skeleton information that is the skeleton information of the person included in each of the plurality of divided images by giving, as an input, each of the plurality of divided images output in step S20 to the posture estimation model. Since the skeleton information is information including the positions of the plurality of feature points such as joints, eyes, and a nose and the connection relationship between the feature points, the posture of the person can be estimated based on the skeleton information.

In a case where the plurality of divided images have been scaled in step S22, in step S26, the CPU 91, as the first output-side scaling unit 16, scales the combined image obtained by combining the plurality of divided images to conform to the size of the input image. In addition, in step S26, the CPU 91, as the first output-side scaling unit 16, maps the first skeleton information acquired in step S24 on the original image before the division (input image). In step S28, the CPU 91, as the first identification unit 18, identifies the first region surrounding the person included in each of the plurality of divided images based on the first skeleton information acquired in step S24. When step S28 is completed, the division processing ends.

Next, the size reduction processing in step S3 will be described in detail with reference to FIG. 8. FIG. 8 is a flowchart illustrating the flow of the size reduction processing. In step S32, the CPU 91, as the second input-side scaling unit 22, outputs the reduced image obtained by reducing the input image acquired in step S1 so as to conform to the restricted size of the posture estimation model. Each of the plurality of divided images is scaled (reduced and/or enlarged) so as to conform to the restricted size of the posture estimation model.

In step S34, the CPU 91, as the second processing unit 24, obtains the second skeleton information that is the skeleton information of the person included in the reduced image by giving, as an input, the reduced image output in step S32 to the posture estimation model.

In step S36, the CPU 91, as the second output-side scaling unit 26, maps the second skeleton information acquired in step S34 on the original image (input image). In step S38, the CPU 91, as the second identification unit 28, identifies the second region surrounding the person included in the reduced image based on the second skeleton information acquired in step S34. When step S38 is completed, the size reduction processing ends.

Next, the selection processing in step S4 will be described in detail with reference to FIG. 9. FIG. 9 is a flowchart illustrating a flow of the selection processing. In step S40, the CPU 91, as the determination unit 30, determines an arbitrary combination of the first skeleton information acquired in step S24 and the second skeleton information acquired in step S34. In step S41, the CPU 91, as the determination unit 30, calculates the area of the overlapping region (hereinafter referred to as the “overlapping area”) in which the first region corresponding to the first skeleton information included in the combination determined in step S40 and the second region corresponding to the second skeleton information included in the combination overlap each other.

In step S42, the CPU 91, as the determination unit 30, calculates the first value obtained by dividing the overlapping area calculated in step S41 by the area of the first region identified in step S28, and compares the first value with the predetermined first threshold. If it is determined in step S42 that the first value is equal to or greater than the first threshold (step S42: Y), the processing proceeds to step S43.

In step S43, the CPU 91, as the determination unit 30, calculates the second value obtained by dividing the area of the first region by the area of the second region, and compares the second value with the predetermined second threshold. If it is determined in step S43 that the second value is equal to or greater than the second threshold (step S43: Y), it is determined that the first skeleton information and the second skeleton information corresponding to the first region and the second region are related to the same person, and the processing proceeds to step S44.

In step S44, the CPU 91 determines, as the selection unit 32, whether or not the first skeleton information and the second skeleton information that have been determined to be related to the same person have a difference in the number of connection relationships (the number of bones) between the feature points included therein. If it is determined that the first skeleton information and the second skeleton information have a difference in the number of connection relationships between the feature points included therein (step S44: Y), the processing proceeds to step S45. In step S45, the CPU 91, as the selection unit 32, selects, between the first skeleton information and the second skeleton information, the one with a larger number of connection relationships between the feature points included therein. Note that one that has not been selected in step S45 between the first skeleton information and the second skeleton information is removed without being used in the subsequent processing. On the other hand, if it is determined that the first skeleton information and the second skeleton information have an equal number of connection relationships between the feature points included therein (N in step S44), the processing proceeds to step S46. In step S46, the CPU 91, as the selection unit 32, selects the first skeleton information out of the first skeleton information and the second skeleton information, and removes the second skeleton information.

In addition, if it is determined in step S42 that the first value is less than the first threshold (N in step S42), it is determined that the first skeleton information and the second skeleton information corresponding to the first region and the second region are related to different persons. Similarly, if it is determined in step S43 that the second value is less than the second threshold (N in step S43), it is determined that the first skeleton information and the second skeleton information corresponding to the first region and the second region are related to different persons.

If it is determined in steps S42 and S43 that the first skeleton information and the second skeleton information are related to different persons, and when steps S45 and S46 are completed, the processing proceeds to step S47. In step S47, the CPU 91, as the selection unit 32, determines whether or not the selection or removal has been completed for all the first skeleton information and the second skeleton information. If the selection or removal for all the first skeleton information and the second skeleton information has not been completed (N in step S47), the processing returns to step S40, and the processing in steps S40 to S47 is repeated for different combinations of the first skeleton information and the second skeleton information. On the other hand, if the selection or removal for all the first skeleton information and the second skeleton information has been completed (step S47: Y), the selection processing ends.

As described above, in the image processing apparatus 1 according to the present embodiment, the division unit 10 divides the input image including at least one person and outputs the plurality of first images (divided images). The first processing unit 14 acquires the first skeleton information that is the skeleton information of the person included in each of the plurality of first images by giving, as an input, each of the plurality of first images to the learned model that has been learned in advance so as to receive an image as an input and to output the skeleton information including the positions of the plurality of feature points and the connection relationship between the feature points for each person included in the input image. The scaling unit (the second input-side scaling unit 22) outputs the second image (reduced image) obtained by reducing the size of the input image. The second processing unit 24 acquires the second skeleton information that is the skeleton information of the person included in the second image by giving the second image as an input to the learned model. The selection unit 32 selects one of the first skeleton information and the second skeleton information based on the first skeleton information and the second skeleton information, and outputs the selected information as the skeleton information for each person included in the input image.

In posture estimation, the result of the posture estimation based on the reduced image including the entire image of the input image is more accurate in some cases, and the result of the posture estimation based on the divided image is more accurate in some cases. According to the image processing apparatus 1 of the present embodiment, the skeleton information is acquired (posture estimation is performed) based on both the divided image obtained by dividing the input image and the reduced image obtained by reducing the size of the input image, and the one estimated to be more accurate between these results is selected as the final output result. Therefore, it is possible to perform posture estimation with high accuracy. In addition, highly accurate posture estimation can be performed, for example, even in a case where there are restrictions on the size of the input image to the posture estimation model, and it is required to divide or reduce the size of a high-definition original image to input the image.

### Second Embodiment

In the first embodiment, the determination unit 30 determines whether the first skeleton information and the second skeleton information corresponding to each other are related to the same person by comparing the first region and the second region for all the combinations of the first skeleton information and the second skeleton information. However, particularly in a case where there are many persons included in the image, the number of combinations of the first skeleton information and the second skeleton information increases, and thus the number of trials increases and the processing time increases.

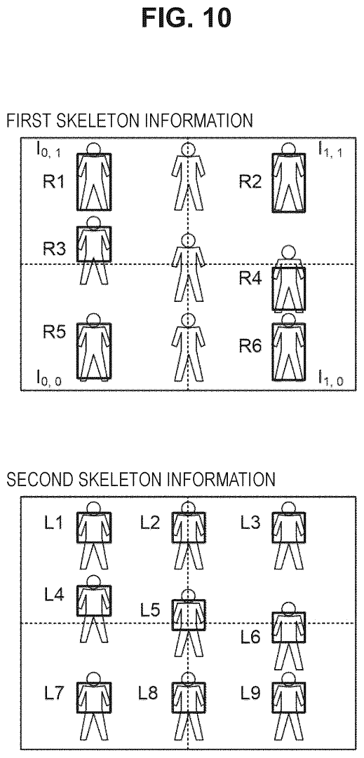

Thus, the determination unit 30 according to a second embodiment does not determine whether the first skeleton information and the second skeleton information are related to the same person for all the combinations of the first skeleton information and the second skeleton information, but determines whether the first skeleton information and the second skeleton information are related to the same person by narrowing down to appropriate combinations. Hereinafter, the function of the determination unit 30 according to the second embodiment will be described with reference to FIG. 10. Note that the functions and configuration related to the image processing apparatus 1 other than the difference in the functions of the determination unit 30 described above are the same as those of the first embodiment, and thus description thereof is omitted.

FIG. 10 is an image illustrating a result (first skeleton information and first regions R1 to R6) of the division processing and a result (second skeleton information and second regions L1 to L9) of the size reduction processing, which are performed on an input image including nine persons. In FIG. 10, the first regions R1 to R6 and the second regions L1 to L9 related to each person are indicated by thick lines. For the sake of clarity, boundary lines used for division by the division processing are illustrated on each image. In addition, in the division processing, an example is illustrated in which the three persons at the center (whose second regions correspond to L2, L5, and L8) are not detected.

The determination unit 30 associates the second region with at least one divided image I_{i,j} based on the position of the second region in the reduced image Iₛ. Next, the determination unit 30 determines whether the first skeleton information and the second skeleton information corresponding to each other are related to the same person by comparing the second region with the first region included in the associated divided image I_{i,j}.

For example, since the second region L1 in FIG. 10 is entirely included in the region corresponding to the divided image I_{0,1}, the determination unit 30 associates the second region L1 with the divided image I_{0,1}. Next, the determination unit 30 determines whether the first regions R1 and R3 are related to the same person by comparing the second region L1 with each of the two first regions R1 and R3 included in the associated divided image I_{0,1}.

In addition, for example, since the second region L6 in FIG. 10 is included in the region corresponding to the two divided images I_{1,1} and I_{1,0}, the determination unit 30 associates the second region L6 with each of the divided images I_{1,1} and I_{1,0}. Next, the determination unit 30 determines whether the first regions R2, R4, and R⁶ are related to the same person by comparing the second region L6 with each of the three first regions R2, R4, and R6 included in the divided images I_{1,1} and I_{1,0}.

As described above, according to the technique of the present embodiment, since the first regions to be combined in the determination of the same person can be narrowed down based on the position of the second region, it is possible to reduce the number of trials and contribute to a decrease in processing time. For example, when the second region L1 is to be compared with all the first regions R1 to R6 as in the first embodiment, a maximum of six trials are required. On the other hand, according to the processing of the determination unit 30 described above, the number of trials can be up to 2.

Note that, the various types of processing executed by the CPU reading software (program) in the above embodiment may be executed by various processors other than the CPU. Examples of the processors in this case include a programmable logic device (PLD) in which a circuit configuration can be changed after manufacturing, such as a field-programmable gate array (FPGA), or the like, and a dedicated electric circuit, or the like, that is a processor having a circuit configuration exclusively designed for executing specific processing, such as an application specific integrated circuit (ASIC). In addition, the various types of processing may be executed by one of the various processors or may be executed by a combination of two or more processors of the same type or different types (for example, a combination of a plurality of FPGAs or a combination of a CPU and an FPGA). Furthermore, a hardware structure of these various processors is, more specifically, an electric circuit in which circuit elements such as semiconductor elements are combined.

In each of the above-described embodiments, an aspect in which the estimation program is stored (installed) in advance in the storage 94 has been described, but the embodiment is not limited thereto. The program may be provided in a form stored in a non-transitory storage medium such as a compact disk read only memory (CD-ROM), a digital versatile disk read only memory (DVD-ROM), or a universal serial bus (USB) memory. Alternatively, the program may be downloaded from an external device via a network.

The technique of the present disclosure can be performed by appropriately combining the above-described embodiments and modifications. The contents described and illustrated above are detailed descriptions of parts according to the technique of the present disclosure, and are merely examples of the technique of the present disclosure. For example, the above description regarding the configuration, function, operation, and effect is a description regarding an example of the configuration, function, operation, and effect of parts according to the technique of the present disclosure. Therefore, unnecessary portions may be deleted from, new elements may be added to, or replacement may be made with the contents described or illustrated above without departing from the gist of the technology of the present disclosure.

The following supplements are further disclosed with regard to the above-described embodiments.

### (Supplement 1)

An image processing apparatus including:
a memory; and
at least one processor connected to the memory;
in which
the processor
is configured to:
divide an input image including at least one person and output plural first images;
obtain first skeleton information that is skeleton information for a person included in each of the plural first images by giving, as an input, each of the plural first images to a learned model that has learned in advance to receive an image as an input and to output the skeleton information including positions of plural feature points and a connection relationship between the feature points for each person included in the input image;
output a second image obtained by reducing the size of the input image;
obtain second skeleton information that is the skeleton information for a person included in the second image by giving, as an input, the second image to the learned model; and
select one of the first skeleton information or the second skeleton information based on the first skeleton information and the second skeleton information and output the selected information as the skeleton information for each person included in the input image.

### (Supplement 2)

A non-transitory storage medium
storing a program executable by a computer to perform image processing, in which
the image processing includes:
dividing an input image including at least one person and output plural first images;
obtaining first skeleton information that is skeleton information for a person included in each of the plural first images by giving, as an input, each of the plural first images to a learned model that has learned in advance to receive an image as an input and to output the skeleton information including positions of plural feature points and a connection relationship between the feature points for each person included in the input image;
outputting a second image obtained by reducing the size of the input image;
obtaining second skeleton information that is the skeleton information for a person included in the second image by giving, as an input, the second image to the learned model; and
selecting one of the first skeleton information or the second skeleton information based on the first skeleton information and the second skeleton information and output the selected information as the skeleton information for each person included in the input image.

### REFERENCE SIGNS LIST

1 Image processing apparatus
10 Division unit
12 First input-side scaling unit
14 First processing unit
16 First output-side scaling unit
18 First identification unit
22 Second input-side scaling unit
24 Second processing unit
26 Second output-side scaling unit
28 Second identification unit
30 Determination unit
32 Selection unit
91 CPU
92 ROM
93 RAM
94 Storage
95 Input unit
96 Display unit
97 Communication I/F
99 Bus
A, B Person
BB1, BB2, BB1a, BB1b, BB2a, BB2b Frame
I_{0,0}, I_{0,1}, I_{1,0}, I_{1,1} (Divided image)
Iᵢₙ Input image
Iₒᵤₜ, Iₒᵤₜ₁, Iₒᵤₜ₂ Output image
Iₛ Reduced image
L1 to L9 Second region
R1 to R6 First region

1. An image processing apparatus, comprising:
a memory; and
at least one processor coupled to the memory, the at least one processor being configured to:
divide an input image including at least one person and output a plurality of first images;
obtain first skeleton information that is skeleton information for a person included in each of the plurality of first images by giving, as an input, each of the plurality of first images to a learned model that has learned in advance to receive an image as an input and to output the skeleton information including positions of a plurality of feature points and a connection relationship between the feature points for each person included in the input image;
output a second image obtained by reducing the size of the input image;
obtain second skeleton information that is the skeleton information for a person included in the second image by giving, as an input, the second image to the learned model; and
select one of the first skeleton information or the second skeleton information based on the first skeleton information and the second skeleton information and outputs the selected information as the skeleton information for each person included in the input image.

2. The image processing apparatus according to claim 1, wherein the at least one processor is configured to:
identify a first region surrounding the person included in each of the plurality of first images based on the first skeleton information;
identify a second region surrounding the person included in the second image based on the second skeleton information;
determine whether the first skeleton information and the second skeleton information corresponding to each other are related to a same person by comparing the first region with the second region; and
select one of the first skeleton information or the second skeleton information determined to be related to the same person.

3. The image processing apparatus according to claim 2, wherein the at least one processor is configured to:
calculate an overlapping area of the first region with the second region; and
determine whether the first skeleton information and the second skeleton information corresponding to each other are related to the same person based on a comparison result between a first value obtained by dividing the overlapping area by an area of the first region and a predetermined first threshold, and a comparison result between a second value obtained by dividing the area of the first region by an area of the second region and a predetermined second threshold.

4. The image processing apparatus according to claim 2, wherein the at least one processor is configured to:
associate the second region with at least one of the first images based on a position of the second region in the second image; and
determine whether the first skeleton information and the second skeleton information corresponding to each other are related to the same person by comparing the second region with the first region included in the associated first image.

5. The image processing apparatus according to claim 1, wherein the at least one processor is configured to select whichever of the first skeleton information or the second skeleton information has a larger number of connection relationships between the feature points included in the skeleton information.

6. The image processing apparatus according to claim 5, wherein the at least one processor is configured to select the first skeleton information in a case in which the first skeleton information and the second skeleton information have an equal number of connection relationships between the feature points included in the skeleton information.

7. An image processing method, comprising:
dividing an input image including at least one person and outputting a plurality of first images;
obtaining first skeleton information that is skeleton information for a person included in each of the plurality of first images by giving, as an input, each of the plurality of first images to a learned model that has learned in advance to receive an image as an input and to output the skeleton information including positions of a plurality of feature points and a connection relationship between the feature points for each person included in the input image;
outputting a second image obtained by reducing the size of the input image;
obtaining second skeleton information that is the skeleton information for a person included in the second image by giving, as an input, the second image to the learned model; and
selecting one of the first skeleton information or the second skeleton information based on the first skeleton information and the second skeleton information and outputting the selected information as the skeleton information for each person included in the input image.

8. A non-transitory computer-readable storage medium storing an image processing program executable by a computer to perform a process, the process comprising:
dividing an input image including at least one person and outputting a plurality of first images;
obtaining first skeleton information that is skeleton information for a person included in each of the plurality of first images by giving, as an input, each of the plurality of first images to a learned model that has learned in advance to receive an image as an input and to output the skeleton information including positions of a plurality of feature points and a connection relationship between the feature points for each person included in the input image;
outputting a second image obtained by reducing the size of the input image;
obtaining second skeleton information that is the skeleton information for a person included in the second image by giving, as an input, the second image to the learned model; and
selecting one of the first skeleton information or the second skeleton information based on the first skeleton information and the second skeleton information and outputting the selected information as the skeleton information for each person included in the input image.
